(19) United States
(12) Patent Application Publication
(10) Pub. No.: US 2025/0214329 A1
(43) Pub. Date: Jul. 3, 2025

(54) PACKAGING MATERIAL FOR FOOD WITH AN INNER BARRIER LAYER

(71) Applicant: delsci GmbH, Traun (AT)

(72) Inventors: Herwig KIRCHBERGER, Enns (AT); Johannes ZIPFEL, Linz (AT)

(21) Appl. No.: 18/847,355

(22) PCT Filed: Mar. 23, 2023
(86) PCT No.: PCT/EP2023/057491

§ 371 Date: Sep. 16, 2024

(30) Foreign Application Priority Data
Mar. 23, 2022 (DE) 10 2022 106 886.2

(51) Int. Cl. B32B 29/00; B32B 37/24; D21H 21/16; D21H 21/20; D21H 27/10; D21H 27/30

(52) U.S. Cl. CPC B32B 29/005; B32B 37/24; D21H 21/16; D21H 21/20; D21H 27/10; D21H 27/30; B32B 2037/243; B32B 2250/26; B32B 2255/12; B32B 2255/26; B32B 2307/31; B32B 2307/54; B32B 2307/718; B32B 2307/7244; B32B 2307/7246; B32B 2307/7376; B32B 2307/75; B32B 2317/12; B32B 2439/70

(57) ABSTRACT

A packaging material for food is proposed, which packaging material comprises a first and a second paper substrate, wherein a coating is applied on at least one side of the first paper substrate, which coating forms a barrier against the penetration of oxygen, and wherein a coating is applied on at least one side of the second paper substrate, which coating forms a barrier against the penetration of water vapour, and wherein the first and the second paper substrate are connected to one another in the packaging material, with the result that the coating of the first paper substrate and the coating of the second paper substrate face one another.

### FIELD OF THE INVENTION

The invention relates to a packaging material for packaging food. In particular, it relates to a laminate of at least two paper substrates, which are each provided with a coating and are connected such that the coatings face each other. The coatings are better protected from environmental influences thereby. The packaging material can be manufactured easily and is readily recyclable.

### BACKGROUND AND PRIOR ART

There are many varying and partially contradicting requirements on packaging material for food. A first function of the packaging material is to protect the packaged food from environmental influences. This requires at least a certain mechanical strength and a chemical stability against typical environmental influences. A second function is that the packaging material should also protect the environment from influences caused by the packaged food, with which it may potentially come into contact. For food, these two functions primarily require a sufficient resistance against the penetration of fats, oils, water, water vapor and oxygen through the packaging material.

A further important property is a good printability of the packaging material, at least on one side, as many packaging materials for food are printed in order to be able to identify the packaged food and its origin and to provide the packaged food with an attractive exterior.

Because packaging material for food is often used only once, it makes sense for ecological reasons if the packaging material can be recycled as easily as possible or, if it is not disposed of properly, that it can at least biodegrade.

For ecological reasons, fibers from recovered paper are used for the manufacture of packaging materials for food. These fibers can be contaminated with mineral oil-based products, so that one function of the packaging material can also be to reduce the migration of contaminants out of the packaging material into the food.

In order to fulfill these functions as well as possible, packaging materials often consist of a laminate of several layers. Plastic films and aluminum foil form very effective barriers in the laminate and are well known in the art. The packaging material, however, cannot then be recycled easily. For this reason, coated paper substrates are often used as packaging material. These paper substrates have complex layered structures in order to obtain the desired barrier effect. In particular, if the coatings are biodegradable, the coatings need to be protected from environmental influences, which most often can be achieved by further layers or more coating material on the paper substrate. The manufacture of paper substrates with many layers is thus costly and the use of coating materials is inefficient.

Thus, there is a need in the industry to have a packaging material available which forms a good barrier, is recyclable and can be manufactured easily.

### SUMMARY OF THE INVENTION

The objective of the present invention is to provide a packaging material for food, which offers a sufficiently high resistance against the penetration of water vapor and oxygen, can be readily recycled or is biodegradable and can be manufactured comparatively easily.

This objective is achieved by a packaging material according to claim 1 as well as by a process for its manufacture according to claim 50. Advantageous embodiments are described in the dependent claims.

The packaging material according to the invention comprises a first and a second paper substrate,
wherein the first paper substrate comprises cellulose fibers, has a basis weight of at least 20 g/m² and at most 65 g/m² and a coating is applied to at least one side of the first paper substrate which forms a barrier against the penetration of oxygen and the oxygen transmission rate through the first paper substrate at a temperature of 23° C. and a relative humidity of 50% is at least 0.1 cm³/(m²·d·bar) and at most 5000 cm³/(m²·d·bar), and
wherein the second paper substrate comprises cellulose fibers, has a basis weight of at least 20 g/m² and at most 65 g/m² and a coating is applied to at least one side of the second paper substrate which forms a barrier against the penetration of water vapor and the water vapor transmission rate through the second paper substrate at a temperature of 23° C. and a relative humidity of 85% is at least 0.1 g/(m²·d ) and at most 200 g/(m²·d ), and wherein the first and the second paper substrate in the packaging material are connected to each other so that the coating of the first paper substrate and the coating of the second paper substrate face each other.

The inventors have found that the barrier layers on the paper substrates can be efficiently protected from environmental influences, as they are not, as is common in the art, applied to the outside of the packaging material, but instead that a laminate of two coated paper substrates is formed so that the coatings are on the inside and the paper substrates form the outer layers of the packaging material. A good barrier can be formed thereby with comparatively little barrier material and there is no necessity to protect the barrier layers from environmental influences by more barrier material or by additional layers.

Furthermore, such a packaging material can be manufactured efficiently by first manufacturing and coating the two paper substrates, for example, on a paper machine, and connecting them to each other on a further machine. Thus, there is no necessity to apply several layers on the paper substrate on an additional device.

Furthermore, such a packaging material is readily recyclable, because plastic films or aluminum foil can be avoided and for recycling, it is therefore not necessary to separate the layers of the packaging material from each other.

Finally, the paper substrate facing away from the packaged food can, for example, contain fibers from recovered paper because, due to the barrier between both paper substrates, the migration of contaminants from the fibers of recovered paper into the packaged food is hindered. This is a further ecological advantage of the invention.

The first paper substrate has a basis weight of at least 20 g/m² and at most 65 g/m², preferably at least 25 g/m² and at most 45 g/m².

The second paper substrate has a basis weight of at least 20 g/m² and at most 65 g/m², preferably at least 25 g/m² and at most 45 g/m².

The basis weight can be determined in accordance with ISO 536:2019 and refers to the basis weight of each paper substrate, i.e. without coating.

The basis weight of the first and second paper substrate can be relatively low because, due to the lamination of the paper substrates, the packaging material according to the invention has good mechanical strength which, for a packaging material consisting of a single coated paper substrate, can only be achieved with a substantially higher basis weight. A further advantage of the packaging material according to the invention results thereby, as material can be saved. The packaging material also remains flexible and is therefore particularly well-suited to flexible packaging, in contrast to cardboard.

The first paper substrate comprises cellulose fibers, wherein the cellulose fibers are preferably sourced entirely or partially from coniferous trees, deciduous trees, spruce, pine, fir, beech, birch, eucalyptus, hemp, flax, sisal, abaca or esparto grass, or are entirely or partially formed by a mixture of cellulose fibers from two or more of these plants. Additionally or alternatively, the cellulose fibers of the first paper substrate can be formed entirely or partially by fibers from regenerated cellulose.

In the first paper substrate, the cellulose fibers preferably make up at least 50% and at most 100% and particularly preferably at least 60% and at most 100% and more particularly preferably at least 60% and at most 95% of the mass of the paper substrate.

The second paper substrate comprises cellulose fibers, wherein the cellulose fibers are preferably sourced entirely or partially from coniferous trees, deciduous trees, spruce, pine, fir, beech, birch, eucalyptus, hemp, flax, sisal, abaca or esparto grass, or are entirely or partially formed by a mixture of cellulose fibers from two or more of these plants. Additionally or alternatively, the cellulose fibers of the second paper substrate can be formed entirely or partially by fibers from regenerated cellulose.

In the second paper substrate, the cellulose fibers preferably make up at least 50% and at most 100% and particularly preferably at least 60% and at most 100% and more particularly preferably at least 60% and at most 95% of the mass of the paper substrate.

The cellulose fibers of the first or second paper substrate can be bleached or unbleached, wherein preferably, at least 20% and at most 100%, particularly preferably at least 50% and at most 90% of the mass of the cellulose fibers in the first or second paper substrate are unbleached. Preferably, at least 20% and at most 100%, particularly preferably at least 50% and at most 90% of the mass of the cellulose fibers are unbleached in that of the two paper substrates which is intended to face the packaged food.

The manufacture of unbleached cellulose fibers is ecologically better, because the bleaching process is avoided. The paper substrate then has a brownish color, and it is more difficult to print it in an optically appealing way. Therefore, it is preferable for the paper substrate which is not visible from the outside, i.e. the paper substrate facing the packaged food, to contain unbleached cellulose fibers.

The cellulose fibers of the first or the second paper substrate can preferably be sourced from recovered paper, wherein at least 20% and at most 100%, particularly preferably at least 50% and at most 90% of the mass of the cellulose fibers in the first or second paper substrate are sourced from recovered paper. Preferably, at least 20% and at most 100%, particularly preferably at least 50% and at most 90% of the mass of the cellulose fibers in that of the two paper substrates that is intended to face the packaged food is sourced from recovered paper. Cellulose fibers from recovered paper can contain contaminants, for example, from mineral oil-based products, that should not migrate into the food. The use of cellulose fibers from recovered paper, however, offers ecological advantages, therefore it is preferable for the paper substrate facing away from the packaged food to contain cellulose fibers from recovered paper, because the coatings located between the paper substrates reduce the migration of contaminants into the food.

The first paper substrate can contain filler material, wherein the filler material is preferably selected from the group consisting of calcium carbonate, magnesium hydroxide, aluminum hydroxide, titanium dioxide, magnesium oxide, talcum, kaolin, silicates, nanocellulose and mixtures thereof.

The second paper substrate can contain filler material, wherein the filler material is preferably selected from the group consisting of calcium carbonate, magnesium hydroxide, aluminum hydroxide, titanium dioxide, magnesium oxide, talcum, kaolin, silicates, nanocellulose and mixtures thereof.

The first paper substrate can contain filler material, wherein the filler material preferably makes up at least 1% and at most 45% and particularly preferably at least 5% and at most 45% of the mass of the first paper substrate.

The second paper substrate can contain filler material, wherein the filler material preferably makes up at least 1% and at most 45% and particularly preferably at least 5% and at most 45% of the mass of the second paper substrate.

The filler material in the first or second paper substrate can increase the brightness of the paper substrate and thus improve the optical appearance. The filler material, however, can also contribute to the barrier effect. Furthermore, the filler material can replace a part of the cellulose fibers and thus the paper substrate can be manufactured more cost-effectively.

The first or the second paper substrate can contain further substances, such as additives or process aids, which the skilled person can select with respect to type and amount according to experience. This includes, for example, sizing agents such as alkylketene dimers (AKD) or alkenyl succinic acid anhydrides (ASA), wet strength agent, such as epichlorohydrin, or additives to increase the strength such as starch or cellulose derivatives, for example carboxy methyl cellulose. Process aids, such as de-foamer or dispersing agents, which can preferably be used for the manufacture of the paper substrate, are not intended to remain in the paper substrate, but can be contained in traces.

The first paper substrate preferably has a thickness of at least 30 μm and at most 80 μm, particularly preferably at least 40 μm and at most 60 μm.

The second paper substrate preferably has a thickness of at least 30 μm and at most 80 μm, particularly preferably at least 40 μm and at most 60 μm.

The thickness can be determined in accordance with ISO 534:2011 and refers to the thickness of each paper substrate, i.e. without coating.

The thickness in the preferred or particularly preferred intervals is advantageous, because it slows the migration of contaminants, contributes to the barrier effect of the packaging material according to the invention against the penetration of oxygen and water vapor and provides the packaging material with a good mechanical stability, which enables for a particular efficient further processing of the packaging material.

The first paper substrate can preferably be calendered and has a thickness of at least 30 μm and at most 60 μm.

The second paper substrate can preferably be calendered and has a thickness of at least 30 μm and at most 60 μm.

The calendering of the first or second paper substrate reduces the thickness of the paper substrate and provides it with a smooth surface that can be coated or printed particularly readily.

The first paper substrate preferably has a Gurley air permeability of at least 100 s and at most 50000 s, particularly preferably at least 100 s and at most 45000 s.

The second paper substrate preferably has a Gurley air permeability of at least 100 s and at most 50000 s, particularly preferably at least 100 s and at most 45000 s.

The Gurley air permeability can be determined in accordance with ISO 5636-5:2013 and refers to the air permeability of each paper substrate without coating in at least one of the two directions through the paper substrate.

The air permeability of the first and the second paper substrate is relatively low, so that the packaging material forms a good barrier against the penetration of oxygen and water vapor. With an air permeability in the preferred or particularly preferred intervals, the paper substrate can contribute to the barrier effect and hence less coating material is required in order to achieve a defined barrier effect.

A coating is applied to at least one side of the first paper substrate, which forms a barrier against the penetration of oxygen. The type and amount of the coating are selected thereby such that the first paper substrate has an oxygen transmission rate at a temperature of 23° C. and a relative humidity of 50% of at least 0.1 cm³/(m²·d·bar) and at most 5000 cm³/(m²·d·bar), preferably at least 0.5 cm³/(m²·d·bar) and at most 300 cm³/(m²·d·bar).

The oxygen transmission rate can be determined in accordance with ISO 15105-1:2007, wherein the criterion is satisfied if the oxygen transmission rate lies within the inventive or preferred interval in at least one direction through the paper substrate.

The oxygen transmission rate of the first paper substrate enables a packaging material with a particularly low oxygen transmission rate to be manufactured, so that the food packaged therein can be kept for long periods.

Preferably, the coating of the first paper substrate comprises a polymer that is selected from the group consisting of polyvinyl alcohol, ethylene-vinyl alcohol copolymer, polysaccharides, starches, pectins, glucans or mixtures thereof. Particularly preferably, the polymer is biodegradable and in particular, the polymer is selected from the group consisting of polysaccharides, starches, pectins, glucans or mixtures thereof.

Preferably, the polymer of the coating of the first paper substrate makes up at least 20% and at most 100%, particularly preferably at least 30% and at most 100%, and more particularly preferably at least 40% and at most 90% of the mass of the coating.

Preferably, the basis weight of the coating of the first paper substrate is at least 0.5 g/m² and at most 10 g/m², particularly preferably at least 1 g/m² and at most 5 g/m², wherein the basis weight is the mass of the coating with respect to the area to which the coating is actually applied.

Preferably, the coating of the first paper substrate is applied to at least 50% of the area and at most 100% of the area, particularly preferably to at least 70% of the area and at most 100% of the area and more particularly preferably at least 70% and at most 95% of the area of the first paper substrate.

The first paper substrate can have at least one further layer between the paper substrate and the coating against the penetration of oxygen. In a preferred embodiment, this further layer comprises starch and/or a filler material and the basis weight of this further layer is at least 1 g/m² and at most 5 g/m², wherein the basis weight is the mass of the further layer with respect to the area to which the further layer is actually applied. A homogeneous coating against the penetration of oxygen can be applied more easily thereby.

The preferred type and amount of the coating of the first paper substrate achieve a good barrier against the penetration of oxygen at a low applied amount. Because the coating is located inside the packaging material, it is well protected against environmental influences, in particular water, which can damage the barrier against the penetration of oxygen. A good barrier can therefore be obtained despite the use of relatively less coating material. A full-surface coating is preferred, but using it in packaging often does not require that the entire surface of the paper substrate is in fact coated. As an example, areas in which the packaging material is bonded to itself do not require such a coating, so that in a preferred embodiment, coating material can be saved by applying it only where it is actually needed as a barrier in the packaging.

A coating is applied to at least one side of the second paper substrate, the coating forming a barrier against the penetration of water vapor. The type and amount of the coating are selected here such that the second paper substrate has a water vapor transmission rate at a temperature of 23° C. and a relative humidity of 85% of at least 0.1 g/(m²·d ) and at most 200 g/(m²·d ), preferably at least 0.5 g/(m²·d ) and at most 20 g/(m²·d).

The water vapor transmission rate can be determined in accordance with ISO 2528:2017, wherein the criterion is satisfied if the water vapor transmission rate in at least one direction through the second paper substrate is within the inventive or preferred interval.

The water vapor transmission rate of the second paper substrate enables a packaging material with a particularly good water vapor transmission rate to be manufactured, so that a food packaged therein does not dry out, but also does not get too wet.

Preferably, the coating of the second paper substrate comprises a polymer, and particularly preferably, the polymer is selected from the group consisting of poly(meth)acrylate, polyacrylate, polystyrene, polybutadiene, polyethylene, polyacrylonitrile, polyacrylic acid, polyhydroxy alkanoates, polylactides, waxes, paraffins and mixtures thereof. Particularly preferably, in order to achieve a particularly good barrier against the penetration of water vapor, the polymer is selected from the group consisting of polystyrene, polybutadiene and mixtures thereof.

The particularly preferred polymers are readily biodegradable and offer ecological advantages in the packaging material according to the invention and are therefore selected from the group consisting of polyhydroxy alkanoates, polylactides, food-approved waxes, paraffins and mixtures thereof.

Preferably, the polymer in the coating of the second paper substrate makes up at least 20% and at most 100%, particularly preferably at least 30% and at most 100% and in particular at least 40% and at most 90% of the mass of the coating.

Preferably, the basis weight of the coating of the second paper substrate is at least 0.5 g/m² and at most 10 g/m², particularly preferably at least 1 g/m² and at most 5 g/m², wherein the basis weight is the mass of the coating with respect to the area to which the coating is actually applied.

Preferably, the coating of the second paper substrate is applied to at least 50% of the area and at most 100% of the area, particularly preferably at least 70% of the area and at most 100% of the area and more particularly preferably at least 70% and at most 95% of the area of the second paper substrate.

The second paper substrate can have at least one further layer between the paper substrate and the coating against the penetration of water vapor. In a preferred embodiment, this further layer forms a barrier against the penetration of oils and fats or the absorption of water. Here, the basis weight of this further layer is preferably at least 1 g/m² and at most 5 g/m², wherein the basis weight is the mass of the further layer with respect to the area to which the further layer is actually applied. Depending on the type of the further layer, the second paper substrate in this preferred embodiment has a water absorption on at least one side, characterized by the Cobb₃₀₀ value, of at least 0.1 g/m² and at most 30 g/m² and particularly preferably at least 0.5 g/m² and at most 10 g/m², and/or the second paper substrate has on at least one side a resistance against the penetration of oil, characterized by the KIT level, of at least 4 and at most 12 and particularly preferably at least 7 and at most 11.

The Cobb₃₀₀ value can be determined in accordance with ISO 535:2014. The KIT level can be determined in accordance with TAPPI T559 (2012).

With this further layer, a homogeneous coating against the penetration of water vapor can be applied to the second paper substrate more easily.

The type and amount of the coating of the second paper substrate produce a good barrier against the penetration of water vapor for a small applied amount.

In the packaging material according to the invention, the first paper substrate with the coating applied thereto and the second paper substrate with the coating applied thereto are connected such that the coating of the first paper substrate and the coating of the second paper substrate face each other.

In a preferred embodiment of the packaging material according to the invention, the connection of the first and the second paper substrate is achieved by at least one of the coatings of the first and the second paper substrate being heat-sealable. In this case, the first and the second paper substrate can be connected to the packaging material according to the invention by elevated temperature and mechanical pressure, without the need for a further adhesive.

In a preferred embodiment of the packaging material according to the invention, the connection of the first and the second paper substrate is achieved by an additional layer of adhesive, wherein this layer is between the coating of the first and the second paper substrate. In this preferred embodiment, the adhesive is preferably selected from the group consisting of heat-sealable adhesives, cold-sealable adhesives, solvent-based adhesives and water-based adhesives.

When selecting the adhesive, care has to be taken that it is compatible with the coatings of the first and the second paper substrate. This means that the adhesive enables for a good connection of the coated paper substrates without damaging the coatings. Here, the adhesive itself can also contribute to the barrier effect of the coating of the first or the second paper substrate or form an additional barrier, for example against the penetration of fats or oils.

In this preferred embodiment, the thickness of the layer of adhesive is particularly preferably at least 1 μm and at most 10 μm and particularly preferably at least 2 μm and at most 7 μm.

The packaging material according to the invention can include further coatings, which are applied to at least one or to both sides of the packaging material.

In a preferred embodiment of the packaging material according to the invention, a coating material is applied to that side of the packaging material which is intended to form the outside, i.e. is facing away from the packaged food. In this preferred embodiment, the coating material preferably forms a barrier against the penetration of oxygen, water vapor, water, fats or oils.

In a preferred embodiment of the packaging material according to the invention a coating material is applied to that side of the packaging material which is intended to form the outside, i.e. is facing away from the packaged food. In this preferred embodiment, the coating material serves to improve the printability.

In a preferred embodiment of the packaging material according to the invention, that side of the packaging material is printed which is intended to form the outside, i.e. is facing away from the packaged food.

In a preferred embodiment of the packaging material according to the invention, a coating material is applied to that side of the packaging material which is intended to form the inside, i.e. is facing towards the packaged food. In this preferred embodiment, the coating material preferably forms a barrier against the penetration of oxygen, water vapor, water, fats or oils.

In a preferred embodiment of the packaging material according to the invention, an adhesive is applied to that side of the packaging material which is intended to form the inside, i.e. is facing towards the packaged food. In this preferred embodiment, the adhesive is preferably a heat-sealable adhesive, a cold-sealable adhesive, a solvent-based adhesive or a water-based adhesive. In a particularly preferred embodiment, the adhesive is only applied to a part of that side of the packaging material, wherein the adhesive is applied to at least 2% and at most 50%, more particularly preferably to at least 3% and at most 30% of the area of that side. This means that the packaging material can bond properly to itself in order to form a packaging.

In a preferred embodiment of the packaging material according to the invention, the packaging material comprises exactly two paper substrates.

In a further preferred embodiment of the packaging material according to the invention, the packaging material comprises exactly three paper substrates, wherein the third paper substrate is arranged between the first and the second paper substrate.

In a preferred embodiment of the packaging material according to the invention, the packaging material comprises any further layers that can particularly preferably be formed by paper substrates, biodegradable films or coating materials, in particular by coating materials that form a barrier against flavors.

In a preferred embodiment of the packaging material according to the invention, no coating material that is intended to form a barrier against water, water vapor, oxygen, fats or oils is applied to that side of the packaging material which is intended to face away from the packaged food.

In a preferred embodiment of the packaging material according to the invention, no coating material that is intended to form a barrier against water, water vapor, oxygen, fats or oils is applied to that side of the packaging material which is intended to face the packaged food.

In a particularly preferred embodiment of the packaging material according to the invention, no coating material that is intended to form a barrier against water, water vapor, oxygen, fats or oils is applied to either of the two sides of the packaging material.

The packaging material according to the invention preferably has a basis weight of at least 41 g/m² and at most 150 g/m², particularly preferably at least 45 g/m² and at most 100 g/m² and more particularly preferably at least 50 g/m² and at most 80 g/m².

The basis weight can be determined in accordance with ISO 536:2019 and refers to the basis weight of the entire packaging material.

Due to the comparatively low basis weight of the packaging material, material can be saved and the packaging material is flexible, so that it can readily be processed further.

The packaging material according to the invention preferably has a thickness of at least 40 μm and at most 250 μm, particularly preferably at least 80 μm and at most 120 μm. The thickness can be determined in accordance with ISO 534:2011 and refers to the thickness of the entire packaging material.

The packaging material according to the invention preferably has a tensile strength of at least 20 N/15 mm and at most 200 N/15 mm, and particularly preferably at least 40 N/15 mm and at most 80 N/15 mm.

The tensile strength can be determined in accordance with ISO 1924-2:2008. The tensile strength can depend on the direction in which the sample for the tensile strength test has been taken from the packaging material. The dependence on the direction, however, is small, so that the criterion is satisfied if the tensile strength in at least one direction lies in the preferred or particularly preferred interval.

The packaging material according to the invention preferably has an elongation at break of at least 1% and at most 4% and particularly preferably at least 2% and at most 3%.

The elongation at break can be determined in accordance with ISO 1924-2:2008. The elongation at break can depend on the direction in which the sample for the elongation at break test is taken from the packaging material. The dependence on the direction, however, is small, so that the criterion is satisfied if the elongation at break in at least one direction lies in the preferred or particularly preferred interval.

The preferred and particularly preferred intervals for tensile strength and elongation at break of the packaging material according to the invention allow particularly good processing to a packaging.

The packaging material according to the invention preferably contains a wet strength agent in the first and/or the second paper substrate and as a whole has a wet strength of at least 3 N/15 mm and at most 20 N/15 mm, particularly preferably at least 5 N/15 mm and at most 10 N/15 mm.

The wet strength can be determined in accordance with ISO 3781:2011 and refers to the whole packaging material.

The wet strength is of importance because on the one hand, the packaging can be exposed to water in the environment and on the other hand, the packaged food, in particular warm food, often releases water vapor, which can condense on the inside of the packaging. In both cases, the packaging material should have a good tensile strength in the wet state. For the same reason, it is also advantageous for the packaging material to absorb little water.

The packaging material according to the invention thus preferably has on a water absorption at least one side, characterized by the Cobb₃₀₀ value, of at least 0.1 g/m² and at most 30 g/m², particularly preferably at least 0.5 g/m² and at most 10 g/m².

The Cobb₃₀₀ value can be determined in accordance with ISO 535:2014.

The packaging material according to the invention preferably has a water vapor transmission rate at a temperature of 23° C. and a relative humidity of 85% of at least 0.1 g/(m²·d) and at most 100 g/(m²·d), particularly preferably at least 0.5 g/(m²·d) and at most 10 g/(m²·d).

The water vapor transmission rate can be determined in accordance with ISO 2528:2017, wherein the criterion is satisfied if the water vapor transmission rate in at least one direction through the packaging material lies in the preferred or particularly preferred interval.

The water vapor transmission rate of the packaging material is an essential parameter to ensure that the packaged food neither dries out nor becomes too wet. With the packaging material according to the invention, a particularly low water vapor transmission rate can be obtained with little coating material.

The packaging material according to the invention preferably has an oxygen transmission rate at 23° C. and a relative humidity of 50% of at least 0.1 cm³/(m²·d·bar) and at most 2000 cm³/(m²·d·bar), particularly preferably at least 0.5 cm³/(m²·d·bar) and at most 100 cm³/(m²·d·bar).

The oxygen transmission rate can be determined in accordance with ISO 15105-1:2007, wherein the criterion is satisfied if the oxygen transmission rate in at least one direction through the packaging material lies in the preferred or particularly preferred interval.

The oxygen transmission rate of the packaging material is an essential parameter in order to ensure that the packaged food is non-perishable for a long time. With the packaging material according to the invention, a particularly low oxygen transmission rate can be obtained with little coating material.

The packaging material according to the invention can be manufactured according to a process according to the invention which comprises the following steps A-E:
A—Providing a first paper substrate comprising cellulose fibers,
B—Applying a coating composition to at least one side of the first paper substrate from step A,
C—Providing a second paper substrate comprising cellulose fibers,
D—Applying a coating composition to at least one side of the second paper substrate from step C,
E—Connecting the coated first paper substrate from step B with the coated second paper substrate from step D, so that the sides of the first and the second paper substrate to which the coating composition has been applied in steps B and D face each other, wherein the first paper substrate in step A has a basis weight of at least 20 g/m² and at most 65 g/m², and
the coating composition in step B contains a material which is capable of forming a barrier against the penetration of oxygen, and the oxygen transmission rate through the first coated paper substrate from step B at a temperature of 23° C. and at a relative humidity of 50% is at least 0.1 cm³/(m²·d·bar) and at most 5000 cm³/(m²·d·bar), and the second paper substrate in step C has a basis weight of at least 20 g/m² and at most 65 g/m², and
the coating composition in step D contains a material which is capable of forming a barrier against the penetration of water vapor and the water vapor transmission rate through the second coated paper substrate from step D at a temperature of 23° C. and a relative humidity of 85% is at least 0.1 g/(m²·d) and at most 200 g/(m²·d).

The first paper substrate from step A has a basis weight of at least 20 g/m² and at most 65 g/m², preferably at least 25 g/m² and at most 45 g/m².

The first paper substrate from step A comprises cellulose fibers, wherein the cellulose fibers are preferably sourced entirely or partially from coniferous trees, deciduous trees, spruce, pine, fir, beech, birch, eucalyptus, hemp, flax, sisal, abaca or esparto grass, or are entirely or partially formed by a mixture of cellulose fibers from two or more of these plants. Additionally or alternatively, the cellulose fibers of the first paper substrate from step A can be formed entirely or partially by fibers from regenerated cellulose.

In the first paper substrate from step A, the cellulose fibers preferably make up at least 50% and at most 100% and particularly preferably at least 60% and at most 100% and more particularly preferably at least 60% and at most 95% of the mass of the first paper substrate.

The first paper substrate from step A can contain filler material, wherein the filler material is preferably selected from the group consisting of calcium carbonate, magnesium hydroxide, aluminum hydroxide, titanium dioxide, magnesium oxide, talcum, kaolin, silicates and mixtures thereof.

The first paper substrate from step A can contain filler material, wherein the filler material preferably makes up at least 5% and at most 45% and particularly preferably at least 25% and at most 45% of the mass of the first paper substrate.

Provision of the first paper substrate in step A preferably comprises manufacturing the paper substrate on a paper machine, particularly preferably on a Fourdrinier paper machine.

Preferably, the material of the coating composition in step B that is capable of forming a barrier against the penetration of oxygen is a polymer selected from the group consisting of polyvinyl alcohol, ethylene-vinyl alcohol copolymer, polysaccharides, starches, pectins, glucans and mixtures thereof. Particularly preferably, the polymer is biodegradable and more particularly preferably, the polymer is selected from the group consisting of polysaccharides, starches, pectins, glucans and mixtures thereof.

Preferably, the coating composition in step B comprises a solvent and particularly preferably, the solvent is water.

Preferably, the material in the coating composition of step B which is capable of forming a barrier against the penetration of oxygen makes up at least 10% and at most 100%, particularly preferably at least 25% and at most 100% and in particular at least 40% and at most 95% of the mass of the coating composition.

The coating composition is applied in step B to at least one side of the first paper substrate from step A, wherein the coating composition is preferably applied to at least 50% of the area and at most 100% of the area, particularly preferably to at least 70% of the area and at most 100% of the area and in particular to at least 70% and at most 95% of the area of the first paper substrate from step A.

The application of the coating composition in step B preferably comprises application in a paper machine or in a separate application device, as well as drying the paper substrate after application of the coating composition.

Particularly preferably, the application of the coating composition in step B is carried out in a size press or a film press of a paper machine.

Particularly preferably, drying of the coating composition in step B is carried out by drying with hot air, contact with heated surfaces, microwave radiation or by infrared radiation.

The second paper substrate from step C has a basis weight of at least 20 g/m² and at most 65 g/m², preferably at least 25 g/m² and at most 45 g/m².

The second paper substrate from step C comprises cellulose fibers, wherein the cellulose fibers are preferably sourced entirely or partially from coniferous trees, deciduous trees, spruce, pine, fir, beech, birch, eucalyptus, hemp, flax, sisal, abaca or esparto grass, or are entirely or partially formed by a mixture of cellulose fibers from two or more of these plants. Additionally or alternatively, the cellulose fibers of the second paper substrate from step C can be formed entirely or partially by fibers from regenerated cellulose.

In the second paper substrate from step C, the cellulose fibers preferably make up at least 50% and at most 100% and particularly preferably at least 60% and at most 100% and more particularly preferably at least 60% and at most 95% of the mass of the second paper substrate.

The second paper substrate from step C can contain filler material, wherein the filler material is preferably selected from the group consisting of calcium carbonate, magnesium hydroxide, aluminum hydroxide, titanium dioxide, magnesium oxide, talcum, kaolin, silicates and mixtures thereof.

The second paper substrate from step C can contain filler material, wherein the filler material preferably makes up at least 5% and at most 45% and particularly preferably at least 25% and at most 45% of the mass of the second paper substrate.

Provision of the second paper substrate in step C preferably comprises manufacturing the paper substrate on a paper machine, particularly preferably on a Fourdrinier paper machine.

Preferably, the material of the coating composition in step D is a polymer and particularly preferably, the polymer is selected from the group consisting of poly(meth)acrylate, polyacrylate, polystyrene, polybutadiene, polyethylene, polyacrylonitrile, polyacrylic acid, polyhydroxy alkanoates, polylactides, waxes, paraffins and mixtures thereof. Particularly preferably, the polymer is selected from the group consisting of polystyrene, polybutadiene and mixtures thereof.

More particularly preferably, the polymer is selected from the group consisting of polyhydroxy alkanoates, polylactides, food-approved waxes, paraffins and mixtures thereof.

Preferably, the coating composition in step D comprises a solvent and particularly preferably, the solvent is water.

Preferably, the material in the coating composition in step B makes up at least 10% and at most 100%, particularly preferably at least 30% and at most 100% and more particularly preferably, at least 40% and at most 95% of the mass of the coating composition.

The coating composition is applied in step D to at least one side of the second paper substrate from step C, wherein the coating composition is applied to at least 50% of the area and at most 100% of the area, particularly preferably to at least 70% of the area and at most 100% of the area and more particularly preferably to at least 70% and at most 95% of the area of the second paper substrate from step C.

The application of the coating composition in step D preferably comprises application in a paper machine or in a separate application device, as well as drying the paper substrate after application of the coating composition.

Particularly preferably, application of the coating composition in step D is carried out in a size press or a film press of a paper machine.

Particularly preferably, the drying of the coating composition in step D is carried out by drying with hot air, contact with heated surfaces, microwave radiation or by infrared radiation.

In a preferred embodiment of the process according to the invention, the connection in step E comprises heat-sealing both paper substrates, wherein particularly preferably, the coating composition in step B or the coating composition in step D comprises a material that enables heat-sealing.

In a preferred embodiment of the process according to the invention, the connection in step E comprises applying an adhesive to the coating of step B or step D, contacting the coated paper substrate from step B and step D and activating the adhesive, wherein particularly preferably, the adhesive is a heat-sealable adhesive. In this particularly preferred case, activating the adhesive consists in warming or heating the same.

In a preferred embodiment of the process according to the invention, the connection in step E comprises applying an adhesive composition to the coating from step B or D, wherein the adhesive composition contains adhesive and a solvent, contacting the coated paper substrates from step B and D and removing the solvent from the adhesive composition, wherein particularly preferably, the solvent is water or an organic solvent.

### BRIEF DESCRIPTION OF THE FIGURES

FIG. 1 shows a cross section through a packaging material according to the invention.

FIG. 2 show a cross section through a further packaging material according to the invention, comprising a layer of adhesive for connecting the paper substrates.

FIG. 3 shows a cross section of a further packaging material according to the invention, comprising several additional layers and printing.

### DESCRIPTION OF THE PREFERRED EMBODIMENT

The advantages of the invention shall be demonstrated by exemplary packaging materials for food according to the invention.

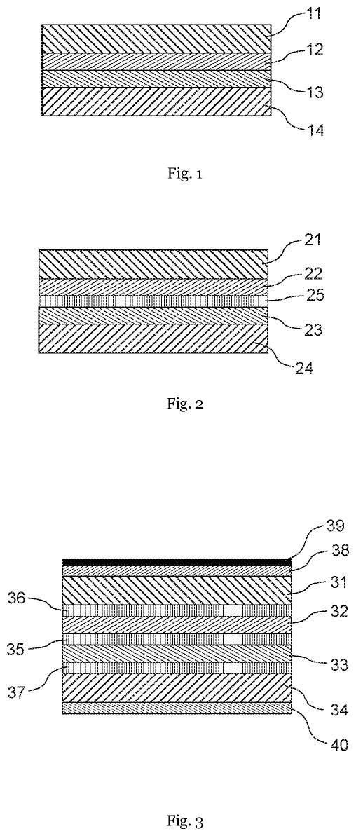

FIG. 1 shows, by way of example, the cross section through a packaging material according to the invention, in which a first paper substrate 11 is connected to a second paper substrate 14, wherein a coating 12 is applied to the first paper substrate 11 which forms a barrier against the penetration of oxygen, and a coating 13 is applied to the second paper substrate 14 which forms a barrier against the penetration of water vapor. The two paper substrates 11 and 14 can be connected by heat-sealing, wherein a heat-sealable material is contained in the coating 12 or the coating 13.

FIG. 2 shows, by way of example, the cross section through a further packaging material according to the invention, in which a first paper substrate 21 is connected to a second paper substrate 24, wherein a coating 22 is applied to the first paper substrate 21 which forms a barrier against the penetration of oxygen, and a coating 23 is applied to the second paper substrate 24 which forms a barrier against the penetration of water vapor. A layer of adhesive 25 connects the two paper substrates 21 and 24 so that the coatings 22 and 23 face each other.

FIG. 3 shows, by way of example, the cross section of a still further packaging material according to the invention, in which a first paper substrate 31 is connected to a second paper substrate 34, wherein a coating 32 is applied to the first paper substrate 31 which forms a barrier against the penetration of oxygen, and a coating 33 is applied to the second paper substrate 34 which forms a barrier against the penetration of water vapor. Additionally, a further layer 36 is applied between the first paper substrate 31 and the coating 32, which, for example, prepares the surface of the paper substrate 31 for the application of the coating 32. A further layer 37 is applied between the second paper substrate 34 and the coating 33, which forms a barrier against the penetration of fats and oils. The two paper substrates 31 and 34 are connected to each other by a layer of adhesive 35, so that the coatings 32 and 33 face each other.

Furthermore, the paper substrate 31 is provided with a layer 38 on the outside, to improve the quality of printing 39. The printed layer 39 is intended to form the outside of the packaging material. A still further layer 40 is applied to the second paper substrate 34, which, for example, can be heat-sealable, to allow the packaging material to bond with itself so that a packaging can be manufactured from the packaging material. Here, the layer 40 is intended to face the packaged food and can, for example, only be applied to those areas that are to be bonded later.

Because the coatings of the first and the second paper substrate are located in the inside of the packaging material, they are well protected and produce good barriers against the penetration of oxygen and water vapor. Thus, further barrier coatings on the packaging material can be dispensed with.

In one embodiment, a first paper substrate was manufactured from cellulose fibers, wherein 50% of the mass of the cellulose fibers were cellulose fibers sourced from coniferous trees and 50% of the mass of the cellulose fibers where cellulose fibers sourced from deciduous trees. The first paper substrate had a basis weight in accordance with ISO 536:2019 of 30 g/m² before coating. It was coated on one side with a composition comprising ethylene-vinyl alcohol copolymer and kaolin as a barrier material, so that after coating, 4.5 g/m² remained on the coated paper substrate. This coating served to form a barrier against the penetration of oxygen. Starch was applied to the other side of the paper substrate to improve printability.

After coating, the tensile strength and the elongation at break in the machine direction were measured in accordance with ISO 1924-2:2008 and values of 50 N/15 mm or 1.8% were found. The tensile strength and the elongation at break were also measured in the cross direction in accordance with ISO 1924-2:2008 and values of 23 N/15 mm or 6.0% were found.

The Cobb₃₀₀ value in accordance with ISO 535:2014 was determined for the side coated with the barrier material and a value of 19 g/m² was found.

The oxygen transmission rate was determined in accordance with ISO 15105-1:2007 at a temperature of 23° C. and a relative humidity of 50% and a value of 62 cm³/(m²·d·bar) was obtained.

The water vapor transmission rate was determined in accordance with ISO 2528:2017 at 23° C. and 85% relative humidity and a value of 350 g/(m²·d) was obtained. Here, the side coated with the barrier material was exposed to the high humidity.

The resistance against the penetration of oil was determined by the KIT test for the side coated with barrier material in accordance with TAPPI T559 (2012) and a value of 1 was obtained.

A second paper substrate was manufactured from cellulose fibers, wherein 40% of the mass of the cellulose fibers were cellulose fibers sourced from coniferous trees and 60% of the mass of the cellulose fibers were cellulose fibers sourced from deciduous trees. The second paper substrate contained 7.5% kaolin as filler material, with respect to the mass of the paper substrate. The second paper substrate had a basis weight in accordance with ISO 536:2019 of 40 g/m² before coating. It was coated on one side with a composition comprising a polymer and a wax as barrier material, so that after coating, 4.5 g/m² remained on the coated paper substrate. The coating served to form a barrier against the penetration of water vapor. Starch was applied to the other side of the paper substrate to improve printability.

After coating, the tensile strength and the elongation at break in the machine direction were measured in accordance with ISO 1924-2:2008 and values of 50 N/15 mm or 2.2% were obtained. The tensile strength and the elongation at break were also measured in the cross direction in accordance with ISO 1924-2:2008 and values of 28 N/15 mm or 7.0% were obtained.

The Cobb₃₀₀ value was determined for the side coated with the barrier material in accordance with ISO 535:2014 and a value of 8 g/m² was found.

The oxygen transmission rate was determined in accordance with ISO 15105-1:2007 at a temperature of 23° C. and a relative humidity of 50% and a value of 30000 cm³/(m²·d·bar) was obtained.

The water vapor transmission rate was determined in accordance with ISO 2528:2017 at 23° C. and 85% relative humidity and a value of 30 g/(m²·d) was obtained. Here, the side coated with the barrier material was exposed to the high humidity.

The resistance against the penetration of oil was determined by the KIT test for the side coated with barrier material in accordance with TAPPI T559 (2012) and a value of 7 was obtained.

To obtain the packaging material according to the invention, the first coated paper substrate and the second coated paper substrate were connected by means of a solvent-based heat-sealable adhesive so that the sides of the paper substrates coated with the barrier material faced each other and were bonded to each other.

The packaging material had a basis weight in accordance with ISO 536:2019 of 81 g/m².

The Cobb₃₀₀ value of the packaging material was determined for the side of the first paper substrate in accordance with ISO 535:2014 and a value of 26 g/m² was found.

The oxygen transmission rate of the packaging material was determined in accordance with ISO 15105-1:2007 at a temperature of 23° C. and a relative humidity of 50% and a value of 56cm³/(m²·d·bar) was obtained.

The water vapor transmission rate of the packaging material was determined in accordance with ISO 2528:2017 at 23° C. and 85% relative humidity and a value of 28 g/(m²·d) was obtained. Here, the side of the packaging material with the second paper substrate was exposed to the high humidity.

The resistance against the penetration of oil was determined by the KIT test for the side of the packaging material with the second paper substrate in accordance with TAPPI T559 (2012) and a value of 1 was obtained.

It was found that without further coatings to protect the barrier materials and without the use of plastic films or aluminum foils, a packaging material can be manufactured that, because of its transmission rate for oxygen and water vapor, because of its resistance to oils and because of its water absorption, is very well suited to the packaging of food.

1. Packaging material for food, which comprises a first and a second paper substrate, wherein the first paper substrate comprises cellulose fibers, has a basis weight of at least 20 g/m² and at most 65 g/m², and a coating which forms a barrier against the penetration of oxygen is applied to at least one side of the first paper substrate so that the oxygen transmission rate at a temperature of 23° C. and a relative humidity of 50% through the first paper substrate with said coating is at least 0.1 cm³/(m²·d·bar) and at most 5000 cm³/(m²·d·bar), and wherein the second paper substrate comprises cellulose fibers, has a basis weight of at least 20 g/m² and at most 65 g/m², and a coating which forms a barrier against the penetration of water vapor is applied to at least one side of the second paper substrate so that the water vapor transmission rate at a temperature of 23° C. and a relative humidity of 85% through the second paper substrate with said coating is at least 0.1 g/(m²·d) and at most 200 g/(m²·d), and
wherein the first and the second paper substrate in the packaging material are connected to each other so that the coating of the first paper substrate and the coating of the second paper substrate are facing each other.

2. Packaging material according to claim 1, in which the first paper substrate has a basis weight of at least 25 g/m² and at most 45 g/m².

3. Packaging material according to claim 1, in which the second paper substrate has a basis weight of at least 25 g/m² and at most 45 g/m².

4. (canceled)

5. Packaging material according to claim 1, in which the cellulose fibers in the first paper substrate make up at least 60% and at most 95% of the mass of the first paper substrate.

6. (canceled)

7. Packaging material according to claim 1, in which the cellulose fibers in the second paper substrate make up at least 60% and at most 95% of the mass of the paper substrate.

8-10. (canceled)

11. Packaging material according to claim 1, in which at least 20% and at most 100%, of the mass of the cellulose fibers in that of the two paper substrates which is intended to face away from the packaged food during the intended use is sourced from recovered paper.

12-14. (canceled)

15. Packaging material according to claim 1, in which the first or the second paper substrate has a thickness of at least 40 μm and at most 60 μm.

16. Packaging material according to claim 1, in which the first or the second paper substrate is calendered and has a thickness of at least 30 μm and at most 60 μm.

17. Packaging material according to claim 1, in which the first or the second paper substrate has a Gurley air permeability of at least 100 s and at most 45000 s.

18. Packaging material according to claim 1, in which the type and amount of the coating which is applied to said at least one side of the first paper substrate is selected such that the first paper substrate has an oxygen transmission rate at a temperature of 23° C. and a relative humidity of 50% of at least 0.5 cm³/(m²·d·bar) and at most 300 cm³/(cm²·d·bar).

19. Packaging material according to claim 1, in which the coating of the first paper substrate comprises a polymer that is selected from the group consisting of polyvinyl alcohol, ethylene-vinyl alcohol copolymer, polysaccharides, starches, pectins, glucans or mixtures thereof.

20. Packaging material according to claim 19, in which the polymer of the coating of the first paper substrate makes up at least 40% and at most 90% of the mass of the coating.

21. Packaging material according to claim 1, in which the basis weight of the coating of the first paper substrate is at least 0.5 g/m² and at most 10 g/m², wherein the basis weight is the mass of the coating with respect to that area to which the coating is actually applied.

22. (canceled)

23. Paper substrate according to claim 1, in which the first paper substrate has at least one further layer between the paper substrate and the coating against the penetration of oxygen.

24. Packaging material according to claim 23, in which said further layer includes starch or a filler material, and the basis weight of this further layer is at least 1 g/m² and at most 5 g/m², wherein the basis weight is the mass of this further layer with respect to the area to which the further layer is actually applied.

25. Packaging material according to claim 1, in which the type and amount of the coating which is applied to said at least one side of the second paper substrate is selected such that the second paper substrate has a water vapor transmission rate at a temperature of 23° C. and a relative humidity of 85% of at least 0.5 g/(m²·d) and at most 20 g/(m²·d).

26. Packaging material according to claim 1, in which the coating of the second paper substrate comprises a polymer, wherein the polymer is selected from the group consisting of poly(meth)acrylate, polyacrylate, polystyrene, polybutadiene, polyethylene, polyacrylonitrile, polyacrylic acid, polyhydroxy alkanoates, polylactides, waxes, paraffins and mixtures thereof.

27. Packaging material according to claim 26, in which the polymer of the coating of the second paper substrate makes up at least 40% and at most 90% of the mass of the coating.

28. Packaging material according to claim 1, in which the basis weight of the coating of the second paper substrate is at least 0.5 g/m² and at most 10 g/m², wherein the basis weight is the mass of the coating with respect to the area to which the coating is actually applied.

29. (canceled)

30. Packaging material according to claim 1, in which the second paper substrate includes at least one further layer between the paper substrate and the coating against the penetration of water vapor.

31. Packaging material according to claim 30, in which said further layer has a basis weight of at least 1 g/m² and at most 5 g/m², wherein the basis weight is the mass of the further layer with respect to the area to which the further layer is actually applied, wherein said further layer forms a barrier against the penetration of oils and fats or the absorption of water, so that the second paper substrate has a water absorption on at least one side characterized by the Cobb₃₀₀ value of at least 0.1 g/m² and at most 30 g/m², and so that the second paper substrate has a resistance against the penetration of oil on at least one side, characterized by the KIT level, of at least 4 and at most 12.

32. Packaging material according to claim 1, in which the coating of the first or the second paper substrate is heat-sealable and said connection between the first and the second paper substrate is obtained by heat-sealing.

33. (canceled)

34. (canceled)

35. Packaging material according to claim 1, in which a further coating material is applied to that side of the packaging material which is intended to face away from the packaged food during the intended use of the packaging material, wherein the further coating material forms a barrier against the penetration of oxygen, water vapor, water, fats, or oils, or wherein the further coating material improves the printability of the side facing away from the packaged food.

36. (canceled)

37. Packaging material according to claim 1, in which a further coating material is applied to that side of the packaging material which is intended to face the packaged food during the intended use of the packaging material, wherein the further coating material forms a barrier against the penetration of oxygen, water vapor, water, fats, or oils.)

38. (canceled)

39. (canceled)

40. Packaging material according to claim 1, wherein the packaging material comprises exactly two paper substrates.

41. Packaging material according to claim 1, wherein the packaging material comprises exactly three paper substrates, wherein the third paper substrate is arranged between the first and the second paper substrate.

42. Packaging material according to claim 1, with a basis weight of at least 50 g/m² and at most 80 g/m².

43. Packaging material according to claim 1, with a thickness of at least 80 μm and at most 120 μm.

44. Packaging material according to claim 1, with a tensile strength of at least 40 N/15 mm and at most 80 N/15 mm.

45. Packaging material according to claim 1, with an elongation at break of at least 2.0% and at most 3.0%.

46. Packaging material according to claim 1, wherein the packaging material contains a wet strength agent in the first or the second paper substrate and as a whole has a wet strength of at least 5 N/15 mm and at most 10 N/15 mm.

47. Packaging material according to claim 1, which has a water absorption on at least one side, characterized by the Cobb₃₀₀ value of at least 0.1 g/m² and at most 30 g/m².

48. Packaging material according to claim 1, which has a water vapor transmission rate at a temperature of 23° C. and a relative humidity of 85% of at least 0.1 g/(m²·d) and at most 100 g/(m²d).

49. Packaging material according to claim 1, which has an oxygen transmission rate at a temperature of 23° C. and a relative humidity of 50% of at least 0.1 cm³/(cm²·d·bar) and at most 2000 cm³/(cm²·d·bar).

50. Process for manufacturing a packaging material, comprising the following steps A-E:
A—providing a first paper substrate comprising cellulose fibers,
B—applying a coating composition to at least one side of the first paper substrate from step A,
C—providing a second paper substrate comprising cellulose fibers,
D—applying a coating composition to at least one side of the second paper substrate from step C,
E—connecting the coated first paper substrate from step B with the coated second paper substrate from step D, so that the sides of the first and the second paper substrate to which the coating composition has been applied in steps B and D face each other, wherein
the first paper substrate in step A has a basis weight of at least 20 g/m² and at most 65 g/m², and the coating composition in step B contains a material which is capable of forming a barrier against the penetration of oxygen, so that the oxygen transmission rate at a temperature of 23° C. and at a relative humidity of 50% through the first coated paper substrate from step B is at least 0.1 cm³/(m²·d·bar) and at most 5000 cm³/(m²·d·bar), and
the second paper substrate in step C has a basis weight of at least 20 g/m² and at most 65 g/m², and
the coating composition in step D contains a material which is capable of forming a barrier against the penetration of water vapor so that the water vapor transmission rate at a temperature of 23° C. and a relative humidity of 85% through the second coated paper substrate from step D is at least 0.1 g/(m²·d) and at most 200 g/(m²·d).

51. Process according to claim 50, in which the packaging material is a packaging material according to claim 1.

52. (canceled)

53. Process according to 50, in which said material of the coating composition in step B that is capable of forming a barrier against the penetration of oxygen is a polymer selected from the group consisting of polyvinyl alcohol, ethylene-vinyl alcohol copolymer, polysaccharides, starches, pectins, glucans or mixtures thereof, wherein the coating composition in step B comprises a solvent, wherein the solvent is formed by water.

54. Process according to claim 50, in which the material of the coating composition in step B that is capable of forming a barrier against the penetration of oxygen makes up at least 40% and at most 95% of the mass of the coating composition.

55. (canceled)

56. Process according to claim 50, in which the application of the coating composition in step B or D is carried out in a size press or film press of a paper machine.

57. (canceled)

58. Process according to claim 50, in which the material of the coating composition in step D that is capable of forming a barrier against the penetration of water vapor is a polymer that is selected from the group consisting of poly(meth)acrylate, polyacrylate, polystyrene, polybutadiene, polyethylene, polyacrylonitrile, polyacrylic acid, polyhydroxy alkanoates, polylactides, waxes, paraffins and mixtures thereof, wherein the coating composition in step D further comprises a solvent, wherein the solvent is formed by water.

59. Process according to claim 50, in which the material of the coating composition in step D that is capable of forming a barrier against the penetration of water vapor makes up at least 40% and at most 95% of the mass of the coating composition.

60. Process according to claim 50, in which the connection in step E comprises heat-sealing both paper substrates, wherein the coating composition in step B or the coating composition in step D comprises a material that enables heat-sealing.

61. (canceled)

62. Process according to claim 50, in which the connection in step E comprises applying an adhesive composition to the coating of step B or step D, wherein the adhesive composition contains adhesive and a solvent, contacting of the coated paper substrates from step B and step D and removing the solvent from the adhesive composition, wherein the solvent is water or an organic solvent.

63. Packaging material according to claim 1, which has a water absorption on at least one side, characterized by the Cobb₃₀₀ value of at least 0.5 g/m² and at most 10 g/m².
